(19) United States
(12) Patent Application Publication
(10) Pub. No.: US 2026/0085147 A1
(43) Pub. Date: Mar. 26, 2026

(54) SOLVENT-BORNE COATING COMPOSITIONS COMPRISING A WATER-DISPERSIBLE POLYISOCYANATE

(71) Applicant: PPG Industries Ohio, Inc., Cleveland, OH (US)

(72) Inventors: Manuel Enderlein, Besigheim (DE); Maria Elisabeth Geier, Würzburg (DE); Susanne Kläger, Leonberg (DE); Petra Charlotte Kübel, Eppingen (DE); Helena Recio Morato, Ingersheim (DE); Axel Nagel, Oberstenfeld (DE)

(73) Assignee: PPG Industries Ohio, Inc., Cleveland, OH (US)

(21) Appl. No.: 19/110,901

(22) PCT Filed: Sep. 5, 2023
(86) PCT No.: PCT/US2023/073454

§ 371 Date: Mar. 12, 2025

Related U.S. Application Data
(60) Provisional application No. 63/375,922, filed on Sep. 16, 2022.

(51) Int. Cl. C08G 18/08; B05D 7/00; C08G 18/40; C08G 18/42; C08G 18/64; C08G 18/70; C09D 133/08

(52) U.S. Cl. CPC C08G 18/0828; B05D 7/52; C08G 18/4063; C08G 18/4247; C08G 18/6423; C08G 18/706; C09D 133/08

(57) ABSTRACT

The present disclosure relates to solvent-borne coating compositions comprising a water-dispersible polyisocyanate, a method of coating a substrate using such compositions, a substrate comprising the cured coating composition, and the use of water-dispersible polyisocyanates in solvent-borne coating compositions for improving chemical, scratch and/or mar resistance of such coatings.

### FIELD

The present disclosure relates to solvent-borne coating compositions comprising a water-dispersible polyisocyanate, a method of coating a substrate using such compositions, a substrate comprising the cured coating composition, and the use of water-dispersible polyisocyanates in solvent-borne coating compositions for improving chemical, scratch and/or mar resistance of such coatings.

### BACKGROUND

It is often desirable to provide the surface of substrates in various technical fields, such as vehicles, with a cured coating composition simultaneously providing resistance properties and desirable appearance. Conventional solvent-borne multi-component polyurethane coating compositions known in the coating industry often exhibit good appearance properties, such as gloss, but at the same time fail to provide good resistance properties.

Thus, it would be desirable to provide solvent-borne multi-component polyurethane coating compositions providing improved resistance properties, such as scratch resistance, chemical resistance and/or mar resistance, without compromising appearance.

This is achieved by the subject-matter defined in the appended claims. It has surprisingly been found that by including a water-dispersible polyisocyanate having sulfonic acid and/or phosphate ether groups into a solvent-borne coating composition, the chemical and scratch resistance of the cured coating can be improved while not deteriorating or even improving appearance.

### SUMMARY

The present disclosure is directed to a multi-component coating composition, comprising a first solvent-borne component comprising an active hydrogen-containing polyfunctional compound, and a second solvent-borne component comprising a water-dispersible polyisocyanate having sulfonic acid and/or phosphate ether groups.

The present disclosure also is directed to a solvent-borne composition comprising a water-dispersible polyisocyanate having sulfonic acid and/or phosphate ether groups, and at least one solvent selected from the group of aromatics, alkyl acetates, or combinations thereof.

The present disclosure is further directed to a method of coating a substrate comprising applying a coating composition to at least a portion of a surface of a substrate to form a coating layer, the coating composition comprising: a first solvent-borne component comprising an active hydrogen-containing polyfunctional compound, and a second solvent-borne component comprising a water-dispersible polyisocyanate having sulfonic acid and/or phosphate ether groups, with each other.

The present disclosure also is directed to a substrate comprising a cured coating layer obtained from the multi-component coating compositions disclosed herein.

The present disclosure is further directed to a use of a water-dispersible polyisocyanate, which has sulfonic acid and/or phosphate ether groups, as a curing agent in a solvent-borne coating composition for improving chemical resistance, scratch resistance, mar resistance and/or appearance of a coating obtained from said coating composition in comparison to a coating obtained from the same coating composition cured using a polyisocyanate neither having sulfonic acid nor phosphate ether groups.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “a” pigment, and the like refer to one or more of any of these items.

The present disclosure relates to a multi-component coating composition, comprising a first solvent-borne component comprising an active hydrogen-containing polyfunctional compound, and a second solvent-borne component comprising a water-dispersible polyisocyanate having sulfonic acid and/or phosphate ether groups.

The multi-component coating composition may comprise from 50 to 90 wt.-% of the first component and from 10 to 50 wt.-% of the second component, based on the combined total resin solids weight of the first and second components. The multi-component composition may comprise from 50 to 90 wt.-%, such as from 60 to 90 wt.-%, such as from 70 to 90 wt.-%, such as from 80 to 90 wt.-% of the first component and from 10 to 50 wt.-%, such as from 10 to 40 wt.-%, such as from to 30 wt.-%, such as from 10 to 20 wt.-% of the second component, based on the combined total resin solids weight of the first and second component. The multi-component composition may comprise from 50 to 90 wt.-% of the first component and from 10 to 50 wt.-% of the second component, such as from 60 to 90 wt.-% of the first component and from 10 to 40 wt.-% of the second component, such as from 70 to 90 wt.-% of the first component and from 10 to 30 wt.-% of the second component, such as from 80 to 90 wt.-% of the first component and from 10 to 20 wt.-% of the second component, such as from 50 to 80 wt.-% of the first component and from 20 to 50 wt.-% of the second component, such as from 50 to 70 wt.-% of the first component and from 30 to 50 wt.-% of the second component, such as from 50 to 60 wt.-% of the first component and from 40 to 50 wt.-% of the second component, based on the combined total resin solids weight of the first and second component. The multi-component composition may comprise from 70 to 80 wt.-% of the first component and from 20 to 30 wt.-% of the second component, based on the combined total resin solids weight of the first and second component.

The terms “resin,” “resinous,” and the like are used interchangeably with the terms “polymer,” “polymeric,” and the like. Further, the term “polymer” is used herein in its common meaning in the art, referring to macromolecular compounds, i.e., compounds having a relatively high molecular weight (e.g., 500 Da or more), the structure of which comprises multiple repetition units (also referred to as “mers”) derived, actually or conceptually, from chemical species of relatively lower molecular mass. Unless indicated otherwise, molecular weights are on a weight average basis (“M_{w}”) and are determined by gel permeation chromatography using polystyrene standards.

According to the present disclosure, an “active hydrogen-containing polyfunctional compound” refers to a compound containing more than one moiety having a hydrogen atom which, because of its position in the molecule, displays significant activity according to the Zerewitinoff test described by Wohler in the Journal of the American Chemical Society, Vol. 49, p. 3181 (1927). Suitable moieties having an active hydrogen include, but are not limited to, —COOH, —OH, —NH₂, —NH—, —CONH₂, —SH, and —CONH—. The active hydrogen containing polyfunctional compound may be selected from the group consisting of polyols, polyamines, polythiols, and mixtures thereof.

The active hydrogen-containing polyfunctional compound may comprise or may be a polyol. The term “polyol” as used herein refers to a compound having more than one hydroxyl group per molecule, such as 2, 3, 4, 5, 6, or more hydroxyl groups per molecule. The polyol may be an oligomeric or a polymeric compound. In particular, the polyol may be a polymeric polyol.

The polyol may be present in the first solvent-borne component in an amount of at least 30 wt.-%, such as at least 40 wt.-%, such as at least 50 wt.-%, such as at least 60 wt.-%, such as at least 70 wt.-%, such as at least 80 wt.-%, based on the total weight of the resin solids in the first solvent-borne component. The polyol may be present in the first solvent-borne component in an amount of no more than 99.8 wt.-%, such as no more than 95 wt.-%, such as no more than 90 wt.-%, such as no more than 85 wt.-%, based on the total weight of the resin solids in the first solvent-borne component. Ranges of polyol may include, for example, from to 99.8 wt.-%, such as from 30 to 95 wt.-%, such as from 30 to 90 wt.-%, such as from 30 to 85 wt.-%, such as from 40 to 99.8 wt.-%, such as from 50 to 99.8 wt.-%, such as from 60 to 99.8 wt.-%, such as from 70 to 99.8 wt.-%, such as from 80 to 99.8 wt.-%, based on the total weight of the resin solids in the first solvent-borne component. The polyol may be present in the coating composition in the range between any of the above-mentioned values such as from 40 to 95 wt.-%, such as from 50 to 90 wt.-%, such as from 60 to 85 wt.-%, such as from 70 to 85 wt.-%, based on the total weight of the resin solids in the first solvent-borne component.

The polyol in the first solvent-borne component may comprise a (meth)acrylic polyol, a polyester polyol, or a combination thereof.

Suitable (meth)acrylic polyols may be homopolymers or copolymers, which can be obtained by polymerizing one or more hydroxyl functional monomers comprising hydroxylated (meth)acyclic acids and (meth)acrylates. As used herein, the terms “(meth)acrylic acid,” “(meth)acrylate,” and similar terms refer both to the acrylic acid or acrylate and the corresponding methacrylic acid or methacrylate, respectively. Non-limiting examples of acrylic polyols may include acrylic polyols derived from hydroxyethyl (meth)acrylate, hydroxypropyl (meth)acrylate, 4-hydroxybutyl (meth)acrylate, 5-hydroxypentyl (meth)acrylate, 6-hydroxyhexyl (meth)acrylate, 8-hydroxyoctyl (meth)acrylate, 9-hydroxynonyl (meth)acrylate, acrylic polyols derived from glycidyl (meth)acrylate-acid adducts or acrylic acid adducts of the glycidyl ester of neodecanoic acid commercially available under the tradename Cardura™ E10 from Hexion Inc. (Columbus, USA), or combinations thereof. The acrylic polyols may have a hydroxyl value in a range of from 20 to 400 mg KOH/g, such as from 30 to 350 mg KOH/g, such as from 40 to 300 mg KOH/g, such as from 50 to 250 mg KOH/g. The hydroxyl value may be determined according to DIN EN ISO 4629-1:2016. Suitable acrylic polyols that can be used include, but are not limited to, acrylic polyol resins commercially available under the trademark SETALUX®, such as SETALUX®1776 VS-65, SETALUX®1774 SS-70, SETALUX®1797 SS-70, SETALUX®1762 W-70, SETALUX®1760 VB-64, SETALUX®1795 VX-74, SETALUX® D A 870 BA, commercially available from Allnex Germany GmbH (Frankfurt, Germany) and acrylic polyol resins, commercially available under the trademark VIACRYL@, such as VIACRYL SC 370/75SNA, commercially available from Allnex Germany GmbH (Frankfurt, Germany).

Suitable polyester polyol resins may be prepared in a known manner, e.g., by condensation of polyhydric alcohol and polycarboxylic acids or by ring-opening polymerization of lactones. Suitable polyhydric alcohols include, but are not limited to, alkylene glycols, such as ethylene glycol, propylene glycol, butylene glycol, 1,6-hexylene glycol, diethylene glycol, dipropylene glycol, triethylene glycol, tripropylene glycol, polyethylene glycol having a molecular weight in the range of from 200 to 10,000 g/mol, polypropylene glycol having a molecular weight in the range of from 200 to 10,000 g/mol, polybutylene glycol having a molecular weight in the range of from 300 to 10,000 g/mol and neopentyl glycol; bisphenol A; hydrogenated bisphenol A; bisphenol F; hydrogenated bisphenol F; cyclohexanediol; propanediols such as 1,2-propanediol, 1,3-propanediol, 2-methyl-1,3-propanediol and 2-ethyl-2-butyl-1,3-propanediol; butanediols such as 1,4-butanediol, 1,3-butanediol, 2,3-butanediol, 1,2-butanediol, 3-methyl-1,2-butanediol and 2-ethyl-1,4-butanediol; pentanediols such as 1,2-pentanediol, 1,5-pentanediol, 1,4-pentanediol, 3-methyl-4,5-pentanediol and 2,2,4-trimethyl-1,3-pentanediol; hexanediols such as 1,6-hexanediol, 1,5-hexanediol, 1,4-hexanediol and 2,5-hexanediol; poly(caprolactone)diols having a molecular weight in the range of from 400 to 10,000 g/mol; polyether glycols, such as poly(oxytetramethylene) glycol; trimethylolpropane; pentaerythritol; dipentaerythritol; trimethylolethane; trimethylolbutane; dimethylolcyclohexane and glycerol. Suitable polycarboxylic acids may include, but are to limited to, maleic acid; fumaric acid; itaconic acid; adipic acid; azelaic acid; succinic acid; sebacic acid; glutaric acid; phthalic acid; isophthalic acid; 5-tert-butylisophthalic acid; tetrachlorophthalic acid; trimellitic acid; naphthalene dicarboxylic acid; naphthalene tetracarboxylic acid; terephthalic acid, hexahydrophthalic acid; methyl hexahydrophthalic acid; dimethyl terephthalic acid; cyclohexane dicarboxylic acids, such as 1,3-cyclohexane dicarboxylic acid; 1,4-cyclohexane dicarboxylic acid; tricyclodecanepolycarboxylic acid, endomethylenetetrahydrophthalic acid; endoethylenehexahydrophthalic acid; cyclohexane tertracarboxylic acids; cyclobutanetetracarboxylic acid and anhydrides, acid halides, or esters of all the aforementioned polyacids. Suitable lactones may include, but are not limited to, β-propiolactone; γ-butyrolactone; δ-valerolactone; ε-caprolactone; α-angelica lactone; and mixtures thereof. Suitable polyester polyols that can be used include, but are not limited to, polyester polyol resins commercially available under the trademark SETAL®, such as SETAL® 1715 VX-74, SETAL® 91703 SS-53, and SETAL® 91715 SS-55, commercially available from Allnex Germany GmbH (Frankfurt, Germany). Suitable polyester polyols that can be used include, but are not limited to, branched polyester polyols exemplified by branched polyester polyol resins under the trademark Basonol®, such as Basonol HPE 1170 B commercially available from BASF SE (Ludwigshafen, Germany), or Baycoll® AV 2113 commercially available from Covestro (Leverkusen, Germany).

The active hydrogen-containing polyfunctional compound according to the present disclosure may comprise or may be a polyamine. The term “polyamine” as used herein refers to a compound having more than one amino group per molecule, such as 2, 3, 4, 5, 6, or more amino groups per molecule. Suitable polyamines include, but are not limited to, ethylene diamine; hexamethylene diamine; 1-methyl-2,6-cyclohexane diamine; tetrahydroxypropylene ethylene diamine; 2,2,4- and 2,4,4-trimethyl-1,6-hexanediamine; 4,4′-bis-(sec-butylamino)-dicyclohexylmethane; 1,4-bis-(sec-butylamino)-cyclohexane; 1,2-bis-(sec-butylamino)-cyclohexane; derivatives of 4,4′-bis-(sec-butylamino)-dicyclohexylmethane; 4,4′-dicyclohexylmethane diamine; 1,4-cyclohexane-bis-(methylamine); 1,3-cyclohexane-bis-(methylamine); diethylene glycol di-(aminopropyl)ether; 2-methylpentamethylene-diamine: diaminocyclohexane; diethylene triamine; triethylene tetramine; tetraethylene pentamine; propylene diamine; 1,3-diaminopropane; imido-bis-propylamine; isophoronediamine; 4,4′-methylenebis-(2-chloroaniline); 3,5-dimethylthio-2,4-toluenediamine; 3,5-dimethyithio-2,6-toluenediamine; 3,5-diethylthio-2,4-toluenediamine; 3,5-diethylthio-2,6-toluenediamine; 4,4′-bis-(sec-butylamino)-diphenylmethane and derivatives thereof; 1,4-bis-(sec-butylamino)-benzene; 1,2-bis-(sec-butylamino)-benzene; N,N′-dialkylamino-diphenylmethane; trimethyleneglycol-di-p-aminobenzoate; polytetramethyleneoxide-di-p-aminobenzoate; 4,4′-methylenebis-(3-chloro-2,6-diethyleneaniline); 4,4′-methylenebis-(2,6-diethylaniline); meta-phenylenediamine; para-phenylenediamine; and mixtures thereof. The polyamine may have a molecular weight of 64 g/mol or greater. The polyamine may have a molecular weight of 2000 g/mol or less.

The active hydrogen-containing polyfunctional compound according to the present disclosure may comprise or may be a polythiol. The term “polythiol” as used herein refers to a compound having more than one thiol group per molecule, such as 2, 3, 4, 5, 6, or more thiol groups per molecule. Suitable polythiols include, but are not limited to, linear or branched aliphatic, cycloaliphatic, aromatic, heterocyclic, polymeric, or oligomeric dithiols, such as 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, dimercaptodiethylsulfide (DMDS), 1,3-dimercapto-3-methylbutane, dipentenedimercaptan, ethylcyclohexyldithiol (ECHDT), methyl-substituted dimercaptodiethylsulfide, dimethyl-substituted dimercaptodiethylsulfide, 3,6-dioxa-1,8-octanedithiol, 1,5-dimercapto-3-oxapentane, 2,5-dimercaptomethyl-1,4-dithiane (DMMD), ethylene glycol di(2-mercaptoacetate), ethylene glycol di(3-mercaptopropionate), benzenedithiol, 4-tert-butyl-1,2-benzenedithiol, 4,4′-thiodibenzenethiol; as well as higher-functional polythiols, such as pentaerythritol tetrakis(2-mercaptoacetate), pentaerythritol tetrakis(3-mercaptopropionate), trimethylolpropane tris(2-mercaptoacetate), trimethylolpropane tris(3-mercaptopropionate), and thioglycerol bis(2-mercaptoacetate), and mixtures of any of the foregoing.

The second solvent-borne component of the multi-component composition according to the present disclosure comprises a water-dispersible polyisocyanate having sulfonic acid and/or phosphate ether groups and may further optionally comprise a second polyisocyanate having neither sulfonic acid nor phosphate ether groups.

Polyisocyanates according to the present disclosure can be aliphatic, aromatic, or a mixture thereof. As used herein, the term “aliphatic” refers to acyclic or cyclic, saturated or unsaturated hydrocarbon compounds. As used herein, the term “aromatic” refers to chemical compounds that contain one or more rings with pi electrons delocalized all the way around them. As used herein, the term “polyisocyanate” is intended to include blocked polyisocyanates as well as unblocked polyisocyanates. As used herein, the term “blocked polyisocyanate” refers to adducts derived from the equilibrium reaction of an isocyanate with a blocking agent, whereby the adduct is thermally instable and dissociates (unblocks) at elevated temperatures, such as temperatures above 100° C. or above 120° C. The term “unblocked isocyanate” refers to a polyisocyanate having free isocyanate groups, i.e., polyisocyanates without blocking agents. The polyisocyanate may be prepared from a variety of isocyanate-containing materials. Examples of suitable polyisocyanates include trimers prepared from, but not limited to, toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. Isocyanate groups of the polyisocyanates may be blocked or unblocked as desired. Examples of suitable blocking agents include those materials which would unblock at elevated temperatures, e.g., at temperatures above 100° C., such as lower aliphatic alcohols having 1 to 6 carbon atoms including methanol, ethanol, and n-butanol; cycloaliphatic alcohols such as cyclohexanol; aromatic alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as blocking agents. Suitable glycol ethers include ethylene glycol butyl ether, diethylene glycol butyl ether, ethylene glycol methyl ether and propylene glycol methyl ether. Other suitable blocking agents include oximes such as methyl ethyl ketoxime, acetone oxime and cyclohexanone oxime, lactams such as epsilon-caprolactam, pyrazoles such as dimethyl pyrazole, and amines such as dibutyl amine.

The term “water-dispersible polyisocyanate” as used herein, refers to polyisocyanates comprising hydrophilic functional groups in such an amount that the polyisocyanate can be solubilized, stably dispersed, and/or emulsified in water at room temperature (23° C.) without the use of an external surfactant or emulsifier such that the dispersion and/or emulsion, once formed by mixing, will not separate when left to stand at room temperature for at least one hour. As used herein, the term “solubilized” means that the water-dispersible polyisocyanate has a solubility in water of at least 1.0 g/I at room temperature. The water-dispersible polyisocyanates used according to the present disclosure are modified with hydrophilic sulfonic acid or phosphate ether groups. Suitable water-dispersible polyisocyanates having sulfonic acid or phosphate ether groups can be produced by preparing the polyisocyanate as described above and modifying the polyisocyanate by reacting with an ionic compound having a sulfonic acid and/or phosphate ether group. The ionic compound may further have a group reactive with the isocyanate group, such as an alcohol or amine group. Suitable ionic compounds for modifying the polyisocyanate may be exemplified by 2-[(2-aminoethyl)-amino]-ethanesulfonic acid. Alternatively, the water-dispersible polyisocyanates may be prepared by reacting a polyisocyanate as described above with an ester phosphate having a polyoxyalkylene chain, such as polyoxyethylene tridecyl ether phosphate. Water-dispersible polyisocyanates may be trimers prepared from aliphatic diisocyanates. The water-dispersible polyisocyanate may have an NCO content on solids being in the range of from 8 to 25%, such as from 8 to 20%, such as from 8 to 15%, such as from 10 to 25%, such as from 15 to 25%, such as from 20 to 25%. The NCO content may be determined according to DIN EN ISO 11 909:2007-5. As used herein, the term “NCO content on solids” refers to the amount of NCO group based on the total amount of solids of the polyisocyanate once the volatiles are vaporized. The water dispersible polyisocyanate may be prepared from an aliphatic diisocyanate. Suitable water-dispersible polyisocyanates having sulfonic acid or phosphate ether groups can be exemplified by Aquolin 270, or Aquolin 278, commercially available from Wanhua Chemical Group (Yantai, China), by Bayhydur polyisocyanates, such as Bayhydur 2655 and Bayhydur 2547 commercially available from Covestro (Leverkusen, Germany) or Easaqua X M 505 commercially available from Vencorex (Saint-Priest, France).

Suitable polyisocyanates having neither sulfonic acid nor phosphate ether groups used according to the present disclosure can be prepared as described above. Polyisocyanates having neither sulfonic acid nor phosphate ether groups may be trimers prepared from aliphatic diisocyanates. The polyisocyanate having neither sulfonic acid nor phosphate ether groups may have an NCO content on solids being in the range of from 8 to 25%, such as from 8 to 20%, such as from 8 to 15%, such as from 10 to 25%, such as from 15 to 25%, such as from 20 to 25%. The NCO content may be determined according to DIN EN ISO 11 909:2007-5. According to the present disclosure, polyisocyanates having neither sulfonic acid nor phosphate ether groups may be used as a second polyisocyanate in the second component of the multi-component coating composition. The second polyisocyanate may be an aliphatic polyisocyanate. Suitable polyisocyanates that can be used as a second polyisocyanate, having neither sulfonic acid nor phosphate ether groups include, but are not limited to, Desmodur grade polyisocyanates, such as Desmodur DN, Desmodur N 3300, Desmodur IL EA and Desmodur N 3300 BA/SN commercially available from Covestro (Leverkusen, Germany).

The polyisocyanates may be present in the second solvent-borne component in an amount of at least 30 wt.-%, such as at least 40 wt.-%, such as at least 50 wt.-%, such as at least 60 wt.-%, such as at least 70 wt.-%, such as at least 80 wt.-%, based on the total weight of the resin solids in the second solvent-borne component. The polyisocyanates may be present in the second solvent-borne component in an amount of no more than 90 wt.-%, such as no more than 85 wt.-%, such as no more than 80 wt.-%, based on the total weight of the resin solids in the second solvent-borne component. Ranges of polyisocyanate may include, for example, from 30 to 90 wt.-%, such as from 30 to 85 wt.-%, such as from 30 to 80 wt.-%, such as from 40 to 90 wt.-%, such as from 50 to 90 wt.-%, such as from 60 to 90 wt.-%, such as from 70 to 90 wt.-%, such as from 80 to 90 wt.-%, based on the total weight of the resin solids in the second solvent-borne component. The polyisocyanate may be present in the coating composition in the range between any of the above-mentioned values such as from 40 to 85 wt.-%, such as from 50 to 85 wt.-%, such as from 60 to 80 wt.-%, such as from 70 to 85 wt.-%, based on the total weight of the resin solids in the second solvent-borne component.

In compositions according to the present disclosure, when a second polyisocyanate having neither sulfonic acid nor phosphate ether groups is used additionally, the water-dispersible polyisocyanate and the second polyisocyanate may be used in a weight ratio of from 1:10 to 10:1, or of from 5:1 to 1:5, or of from 3:1 to 1:3, or of from 2:1 to 1:2. For example, the water-dispersible polyisocyanate and the second polyisocyanate may be used in a ratio of 1:1.

The first solvent-borne component may further comprise a melamine-based compound. The term “melamine-based compound” refers to melamine (2,4,6-triamino-2-triazine) itself and resins obtained by polymerizing melamine with another compound such as e.g., formaldehyde. The melamine-based compound may have an equivalent weight of from 60 to 300 g/eq. As used herein, the “equivalent weight” refers to the mass of the melamine-based compound having one mole (equivalent) of reactive groups. The melamine-based compound may be present in the first solvent-borne component in an amount of at least 0.2 wt.-%, such as at least 1 wt. %, such as at least 5 wt. %, such as at least 10 wt. %, based on the total weight of resin solids in the first solvent-borne component. The melamine-based compound may be present in the first solvent-borne component in an amount of no more than 30 wt.-%, such as no more than 25 wt.-%, such as no more than 20 wt.-%, such as no more 15 wt. %, based on the total weight of resin solids in the first solvent-borne component. The melamine-based compound may be present in the coating composition in a range between any of the above-mentioned values such as from 0.2 to 30 wt.-%, such as from 0.2 to 25 wt.-%, such as from 0.2 to 20 wt.-%, such as from 0.2 to 15 wt.-%, such as from 1 to 30 wt.-%, such as from 1 to 25 wt.-%, such as from 1 to 20 wt.-%, such as from 1 to 15 wt.-%, such as from 5 to 30 wt.-%, such as from 5 to 25 wt.-%, such as from to 20 wt.-%, such as from 5 to 15 wt.-%, such as from 10 to 30 wt.-%, such as from 10 to 25 wt.-%, such as from 10 to 20 wt.-%, such as from 10 to 15 wt.-%, based on the total weight of resin solids in the first solvent-borne component.

The coating composition may further comprise at least one additional ingredient selected from additional polymers different from the active hydrogen-containing polyfunctional compound described above, ultraviolet light stabilizers, ultraviolet light absorbers, curing catalysts, corrosion inhibitors, adhesion promoters, rheology modifiers, levelling agents, sag control agents, surfactants, fillers, matting agents, abrasion-resistant particles, colorants, anti-oxidants, reactive diluents, plasticizers, and effect pigments. When used, the coating composition may comprise a total of from 0.1 to 45 wt.-% of these additional ingredients, such as from 1 to 40 wt.-%, such as from 1.5 to 35 wt.-%, based on the total solids weight of the coating composition.

As used herein, an “additional polymer different from the active hydrogen-containing polyfunctional compound” refers to polymeric compounds not comprising any of the above mentioned functional active-hydrogen-containing groups and/or not being reactive towards the isocyanate groups of the polyisocyanate under the curing conditions employed. For instance, when the active hydrogen-containing polyfunctional compound comprises or is a polyol, the additional polymer does not represent a polyol, in particular not a (meth)acrylic polyol or a polyester polyol, such as, but not limited to, an acrylic resin different from the acrylic polyol, i.e., not having multiple hydroxy groups, a vinylic resin, a polysiloxane resin, an epoxy resin, a polyamide resin, a copolymer thereof or a mixture thereof.

Suitable acrylic resins, different from acrylic polyols, may be homopolymers or copolymers, which can be obtained by polymerizing one or more monomers comprising substituted or unsubstituted (meth)acrylic acids and (meth)acrylates. The acrylic resin may be of linear, branched, star, grafted, block, alternating, or gradient structure, or comprise any mixture of combinations thereof. Suitable (meth)acrylates can include, but are not limited to, alkyl (meth)acrylates, cycloalkyl (meth)acrylates, alkylcycloalkyl (meth)acrylates, aralkyl (meth)acrylates, alkylaryl (meth)acrylates, aryl (meth)acrylates and functional groups-containing (meth)acrylates. As used herein, the term “functional group” refers to a group that includes one or a plurality of atoms other than hydrogen and sp³ carbon atoms. Examples of functional groups include, but are not limited to, carboxylic acid, amido, isocyanate, urethane, thiol, amino, sulfone, sulfoxide, phosphine, phosphite, phosphate, halide, and the like. Non-limiting examples of acrylic resins may include acrylic resins derived from methyl (meth)acrylate, ethyl (meth)acrylate, propyl (meth)acrylate, butyl (meth)acrylate, iso-butyl (meth)acrylate, 2-ethyl hexyl (meth)acrylate, iso-octyl (meth)acrylate, isobornyl (meth)acrylate, isodecyl (meth)acrylate, lauryl (meth)acrylate, tridecyl (meth)acrylate, tetradecyl (meth)acrylate, hexadecyl (meth)acrylate, octadecyl (meth)acrylate, stearyl (meth)acrylate, benzyl (meth)acrylate, 2-phenoxyethyl (meth)acrylate, 3,3,5-trimethyl-cyclohexyl (meth)acrylate, 3-methylphenyl (meth)acrylate, 1-naphtyl (meth)acrylate, 3-phenyl-n-propyl (meth)acrylate, 2-phenyl-aminoethyl (meth)acrylate, glycidyl (meth)acrylate or combinations thereof.

Suitable vinylic resins may be homopolymers or copolymers, which can be obtained by polymerizing one or more monomers comprising vinyl aromatic compounds, such as styrene and vinyl toluene; nitriles, such as (meth)acrylonitrile; vinyl and vinylidene halides such as vinyl chloride and vinylidene fluoride; and vinyl esters such as vinyl acetate. Suitable vinylic resins that can be used include, but are not limited to, vinylic resins under the trademark LUMIFLON™ available from AGC Chemicals Europe, Ltd. (Amsterdam, Netherlands).

Suitable polysiloxane resins may include, but are not limited to, alkyl substituted polysiloxanes, aryl polysiloxanes, copolymers, blends and mixtures thereof. The alkyl substitution may be selected from short chain alkyl groups having 1 to 4 carbon atoms, such as methyl or propyl. The aryl substitution may comprise phenyl groups. Suitable polysiloxane resins that can be used include, but are not limited to, Silres® 601 or Silres® M 50 E, both commercially available from Wacker Chemie AG (München, Germany), and DOWSIL™ RSN-6018, commercially available from Dow Chemical Company (USA).

Suitable epoxy resins may be prepared in a known manner, e.g., by reacting a compound comprising at least one epoxide functionality and a cyclic co-reactant comprising at least two hydroxyl groups. Examples of suitable compounds comprising one epoxide functionality include, but are not limited to, glycidol; epichlorohydrin; glycidol amines and mixtures thereof. As used herein, the terms “epoxy” and “epoxide” are used interchangeably. Examples of suitable cyclic co-reactants comprising at least two hydroxy groups include, but are not limited to, bisphenol A; hydrated bisphenol A; bisphenol F; hydrated bisphenol F; novolac resins such as phenolic novolac, cresol novolac; and mixtures thereof. Suitable epoxy resins that can be used include, but are not limited to, Eponex 1510, Eponex 1513, Epikote Resin 862 and Epikote Resin 828 commercially available from Hexion (USA), Epodil 757 commercially available from Evonik Corporation (Germany), Araldite GY 2600, Araldite GY 281 and Araldite EPN 1138 commercially available from Huntsman (USA).

Suitable polyamide resins may be prepared in a known manner, e.g., by polymerizing a polyamine and a polyacid or by ring-opening polymerization of lactams. Herein, the term “polyamine” refers to a compound having more than one amine group per molecule, e.g., 2, 3, 4, 5, 6, or more amine groups per molecule. Suitable polyamines include, but are not limited to, aliphatic diamines such as 1,2-ethanediamine, 1,2-propanediamine, 1,3-propanediamine, 1,2-butanediamine, 1,3-butanediamine, 1,4-butanediamine, 1,3-pentanediamine, 1,5-pentanediamine, 1,6-hexanediamine, 2-methyl-1,5-pentanediamine, 2,5-dimethylhexane-2,5-diamine, 2,2,4-trimethyl-1,6-hexanediamine, 2,4,4-trimethyl-1,6-hexanediamine, 1,7-heptanediamine, 1,8-octanediamine, 1,9-nonanediamine and 1,10-decanediamine; cycloaliphatic diamines such as 2,4′-diamino dicyclohexylmethane, 4,4′-diamino dicyclohexylmethane, 3,3′-dimethyl-4,4′-diamino dicyclohexylmethane and 3,3′-diethyl-4,4′-diaminodicyclohexylmethane; and aromatic diamines such as 1,2-benzenediamine, 1,3-benzenediamine, 1,4-benzenediamine, 1,5-naphthalenediamine, 1,8-naphthalenediamine, 2,4-toluenediamine, 2,5-toluenediamine, 2,6-toluenediamine, and 3,3′-dimethyl-4,4′-biphenyldiamine. Non-limiting examples of suitable polyacids may include those listed above for preparing polyesters. Suitable lactams may include, but are not limited to, (3-propiolactam; γ-butyrolactam; 8-valerolactam; C-caprolactam; and mixture thereof. Suitable polyamide resins that can be used include, but are not limited to, polyamide resins commercially available under the trademark Flex-Rez™, such as Flex-Rez™ 0080CS, Flex-Rez™ 1060CS, Flex-Rez™ 1074 CS A, commercially available from Lawter (Chicago, IL, USA).

As used herein, a “hindered amine light stabilizer” refers to a compound comprising an amine functional group which is added to polymeric materials to inhibit or retard their degradation by, e.g., photo-oxidation. Typically, derivatives of tetramethylpiperidine are used. Examples of suitable hindered amine light stabilizers include, but are not limited to, Tinuvin® light stabilizers, such as TINUVIN®292, TINUVIN®123, TINUVIN®328, TINUVIN®622, TINUVIN®783, and TINUVIN®770 available from BASF (Ludwigshafen, Germany).

As used herein, “UV light absorbers and stabilizers” refer to compounds used to absorb UV radiation to reduce the UV degradation of a polymeric material. Examples of suitable UV light absorbers and stabilizers include, but are not limited to CYASORB light stabilizers, such as CYASORB UV-1164L available from Solvay (Houten, Netherlands) and TINUVIN®1130 available from BASF (Ludwigshafen, Germany).

The coating compositions may contain a catalyst to facilitate any desired curing reaction. Any catalyst typically used to catalyze crosslinking reactions may be used, and there are no particular limitations on the catalyst. Non-limiting examples of catalysts include phenyl acid phosphate, sulfonic acid functional catalysts such as dodecylbenzene sulfonic acid (DDBSA), dinonyl naphthalene sulfonic acid, dinonyl naphthalene disulfonic acid, salts of the aforementioned sulfonic acids, complexes of organometallic compounds including tin, zinc, zirconium, strontium or bismuth, such as stannous octoate, butyl stannoic acid, dibutyltin dilaurate (DBTL), dibutyltin diacetate, dibutyltin mercaptide, dibutyltin diacetate, dibutyltin dimaleate, dimethyltin diacetate, dimethyltin dilaurate, 1,4-diazabicyclo[2.2.2]octane, bismuth carboxylates, and the like, tertiary amines, such as 1,8-diazabicyclo[5.4.0]undec-7-en, triethyl amine, and the like, or any combinations of the foregoing catalysts.

Alternatively, the coating compositions may be essentially free of a catalyst. As used throughout this specification the term “essentially free” relates to compositions comprising the respective compound in an amount of less than 0.5 wt.-%, such as 0.2 wt.-% such as 0.1 wt.-%, based on the total weight of the coating composition. The coating compositions may be completely free of catalyst, i.e., the coating compositions may comprise 0 wt.-% of catalyst.

As used herein, the term “corrosion inhibitor” refers to a component that reduces the rate or severity of corrosion of a surface of a metal or metal alloy substrate treated with a composition comprising said corrosion inhibitor in comparison to that of a surface of the same metal or metal alloy substrate treated using the same conditions with the same composition not comprising the corrosion inhibitor.

As used herein, the term “adhesion promoter” refers to any material that, when included in the coating composition, enhances the adhesion of the coating composition compared to the same coating composition not comprising the adhesion promoter. Suitable examples of an adhesion promoter include, but are not limited to a free acid, a phosphatized epoxy resin, an alkoxysilane, or a chlorinated or non-chlorinated polyolefin. As used herein, the term “free acid” is meant to encompass organic and/or inorganic acids that are included as a separate component of the compositions as opposed to any acids that may be used to form a polymer that may be present in the composition. The free acid may comprise tannic acid, gallic acid, phosphoric acid, phosphorous acid, citric acid, malonic acid, boronic acid, a derivative thereof, or a mixture thereof. Suitable derivatives include esters, amides, and/or metal complexes of such acids.

As used herein, a “rheology modifier” refers to a component that adjusts flow behavior of a composition by increasing the viscosity of the composition it is in contact with compared to the same composition which is not in contact with the rheology modifier. Non-limiting examples of rheology modifiers include silica, chemically modified silica (e.g. fumed silica), alumina, chemically modified alumina (e.g. fumed alumina), hectorite clays, such as bentone, a hydrophobically modified ethylene-oxide polymer, a rubber latex such as for example styrene-butadiene rubber particles dispersed in an aqueous liquid medium, cellulose derivatives, polyamide waxes, microgels, solvent borne polymer-based associative thickener, exemplified by BYK-410 commercially available from BYK-Chemie GmbH (Wesel, Germany), or any combination thereof.

As used herein, the term “sag control agent” refers to a compound which minimizes sagging, i.e., defects such as tear drops caused by gravity-driven flow of wet coating compositions when applied to a substrate, in particular a substrate comprising a non-horizontal, e.g., a vertical surface, in comparison that of the same wet coating composition not comprising a sag control agent. Suitable flow control agents, especially sag control agents, may include, but are not limited to those compounds described in U.S. Pat. No. 4,311,622 A, EP 0 192 304 A1 and EP 3 728 482 A1.

Surfactants may be added to the coating composition to aid flow and wetting of the substrate. Suitable surfactants include, but are not limited to alkyl sulphates (e.g., sodium lauryl sulphate); ether sulphates; phosphate esters; sulphonates; and their various alkali, ammonium, and amine salts; aliphatic alcohol ethoxylates; alkyl phenol ethoxylates (e.g., nonyl phenol polyether); salts and/or combinations thereof.

As used herein, an “abrasion-resistant particle” is one that, when used in a coating, will impart some level of abrasion resistance to the coating as compared with the same coating lacking the particles. The abrasion-resistant particles may have a hardness value greater than the hardness value of materials that can abrade a coating. Examples of materials that can abrade a coating may include, but are not limited to, dirt, sand, rocks, glass, carwash brushes, and the like. The hardness value of the abrasion-resistant particles and the materials that can abrade the coating can be determined by any conventional hardness measurement method, such as Vickers or Brinell hardness, or can be determined according to the original Mohs' hardness scale which indicates the relative scratch resistance of the surface of a material on a scale of one to ten. The abrasion-resistant particles may have a Mohs' hardness value of greater than 5, such as greater than 6 and may have a Mohs' hardness value of at least 9, such as 10. Suitable abrasion-resistant particles include organic and/or inorganic particles. Examples of suitable particles include, but are not limited to, diamond particles, such as diamond dust particles, and particles formed from carbide materials, such as titanium carbide, silicon carbide and boron carbide, silica, alumina, alumina silicate, silica alumina, alkali aluminosilicate, borosilicate glass, nitrides including boron nitride and silicon nitride, titanium dioxide, zirconium oxide, zinc oxide, quartz, nepheline syenite, baddeleyite, and eudialyte.

As used herein, the term “colorant” means any substance that imparts color and/or opacity and/or other visual effects to the composition. The term “colorant” includes for example pigments and dyes. The colorant can be added to the coating composition in any suitable form, such as discrete particles, dispersions, solutions and/or flakes. Suitable dyes include, but are not limited to, acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane. Examples of suitable pigments include, but are not limited to, carbazole dioxazine pigments, azo pigments, monoazo pigments, diazo pigments, naphthol AS pigments, salt type (lakes) pigments, benzimidazolone pigments, metal complex pigments, isoindolinone pigments, isoindoline pigments, polycyclic phthalocyanine pigments, quinacridone pigments, perylene pigments, perinone pigments, diketopyrrolo pyrrole pigments, thioindigo pigments, anthraquinone pigments, indanthrone pigments, anthrapyrimidine pigments, flavanthrone pigments, pyranthrone pigments, anthanthrone pigments, dioxazine pigments, triarylcarbonium pigments, quinophthalone pigments, diketo pyrrolo pyrrole red (“DPPBO red”), titanium dioxide, carbon black and mixtures thereof. As used herein, the term “effect pigments” relates to pigments that impart visual effects to the composition or the cured coating. Suitable effect pigments may include, but are not limited to, metal effect pigments and pearlescent pigments, for example mica, aluminum oxide platelets, glass flakes or mixtures thereof.

Suitable examples of anti-oxidants to, e.g., prevent oxidation of resins from heat exposure that extends from production and application or to prevent yellowing of the coating, include, but are not limited to, phenolic anti-oxidants, phosphite anti-oxidants and the like. Suitable anti-oxidants that can be used include, but are not limited to, Irganox® antioxidants, such as Irganox 245, Irganox 1010, and Irganox 1076 commercially available from BASF SE (Ludwigshafen, Germany).

As used herein, a “reactive diluent” refers to a monomer or oligomer which reduces the viscosity of the coating composition and can be co-polymerized during curing of the coating composition. A suitable reactive diluent may have a molecular weight in the range of 100 to 350 g/mol. Suitable examples of reactive diluents include, but are not limited to, epoxy functional compounds, vinyl functional compounds, (meth)acrylate compounds, and combinations thereof.

As used herein, the term “plasticizer” refers to a component which enhances flexibility and reduces brittleness of a resin. Suitable plasticizers include, but are not limited to, phthalate esters, such as dibutylphthalate, butyl benzyl phthalate, diisooctyl phthalate and decyl butyl phthalate; chlorinated paraffins; and hydrogenated terphenyls.

As used herein, a “levelling agent” refers to a compound enhancing the thickness uniformity of the cured coating. Suitable levelling agents that can be used include, but are not limited to, BYK-320 or BYK-306 commercially available from BYK-Chemie GmbH (Wesel, Germany).

Suitable fillers include, but are not limited to, silicon dioxide, barium sulphate, talcum, calcium carbonate and magnesium silicate.

As used herein, the term “matting agent” refers to compounds reducing the gloss of cured coatings compared to the same coatings not comprising the matting agent. Suitable matting agents that can be used include, but are not limited to, ACEMATT® OK 412 or ACEMATT® TS 100 commercially available from Evonik Corporations GmbH (Essen, Germany).

As used herein, the term “solvent-borne coating composition” refers to a coating composition comprising one or more organic solvent(s) as the main component of the liquid carrier and less than 50 wt.-% of water, such as less than 40 wt.-% of water, such as less than 30 wt.-% of water, such as less than 20 wt. % of water, such as less than 10 wt.-% of water, such as less than 5 wt.-% of water, such as less than 2 wt.-% of water, such as less than 1 wt.-% of water, based on the total weight of the liquid carrier, i.e., the combination of organic solvent(s) and water (if present). The solvent-borne coating composition may be essentially free of water, i.e., the solvent-borne coating composition may comprise less than 0.5 wt.-% of water, such as less than 0.2 wt.-% of water, such as less than 0.1 wt.-% of water, based on the total weight of the liquid carrier. The solvent-borne coating composition may be completely free of water, i.e., the solvent-borne coating composition may comprise 0 wt.-% of water based on the total weight of the liquid carrier.

The organic solvent may comprise any suitable organic solvents known in the art. Non-limiting examples of suitable organic solvents may include, but are not limited to, acetates, esters, and ketones, aliphatic and/or aromatic hydrocarbons or mixtures thereof. Typically, the organic solvent of the first and/or second component each independently may comprise an aromatic solvent, an alkyl acetate solvent, an aliphatic solvent, a ketone solvent, or combinations thereof; such as an aromatic solvent, an alkyl acetate solvent, or combinations thereof. As used herein, the term “aromatic solvent” refers to a solvent that contains an aromatic hydrocarbon, such as naphtha, toluene or xylene. As used herein, the term “alkyl acetate solvent” refers to a solvent having an ethanoate group attached to an alkyl chain, such as ethyl acetate. Suitable organic solvents may comprise for example, hexane, heptane, octane, toluene, xylene, ethyl acetate, propyl acetate, isopropyl acetate, butyl acetate, isobutyl acetate, 2-butoxyethyl acetate, amyl acetate, isoamyl acetate, acetone, and the like.

The first and/or second solvent-borne component may be substantially free of water, alcoholic and/or ether solvents, i.e., the first and/or second solvent-borne component may comprise less than 5.0 wt.-%, such as less than 3.0 wt.-%, such as less than 2.0 wt.-%, such as less than 1.0 wt.-% of water, alcoholic and/or ether solvents, based on the total weight of the liquid carrier. The first and/or second solvent-borne component may be essentially free of water, alcoholic and/or ether solvents, i.e., the first and/or second solvent-borne component may comprise less than 0.5 wt.-%, such as less than 0.2 wt.-%, such as less than 0.1 wt.-% of water, alcoholic and/or ether solvents, based on the total weight of the liquid carrier.

The first and/or second solvent-borne component may be substantially free of water, i.e., the first and/or second solvent-borne component may comprise less than 5.0 wt.-%, such as less than 3.0 wt.-%, such as less than 2.0 wt.-%, such as less than 1.0 wt.-% of water, based on the total weight of the liquid carrier. The first and/or second solvent-borne component may be essentially free of water, i.e., the first and/or second solvent-borne component may comprise less than 0.5 wt.-%, such as less than 0.2 wt.-%, such as less than 0.1 wt.-% of water, based on the total weight of the liquid carrier.

The first and/or second solvent-borne component may be substantially free of alcoholic solvents, i.e., the first and/or second solvent-borne component may comprise less than 5.0 wt.-%, such as less than 3.0 wt.-%, such as less than 2.0 wt.-%, such as less than 1.0 wt.-% of alcoholic solvents, based on the total weight of the liquid carrier. The first and/or second solvent-borne component may be essentially free of alcoholic solvents, i.e., the first and/or second solvent-borne component may comprise less than 0.5 wt.-%, such as less than 0.2 wt.-%, such as less than 0.1 wt.-% of alcoholic solvents, based on the total weight of the liquid carrier.

The first and/or second solvent-borne component may be substantially free of ether solvents, i.e., the first and/or second solvent-borne component may comprise less than 5.0 wt.-%, such as less than 3.0 wt.-%, such as less than 2.0 wt.-%, such as less than 1.0 wt.-% of ether solvents, based on the total weight of the liquid carrier. The first and/or second solvent-borne component may be essentially free of ether solvents, i.e., the first and/or second solvent-borne component may comprise less than 0.5 wt.-%, such as less than 0.2 wt.-%, such as less than 0.1 wt.-% of ether solvents, based on the total weight of the liquid carrier.

The present disclosure further relates to a solvent-borne composition comprising a water-dispersible polyisocyanate having sulfonic acid and/or phosphate ether groups, and at least one solvent selected from the groups of aromatics, alkyl acetates, or combinations thereof. Herein, the polyisocyanate refers to the water-dispersible polyisocyanate having sulfonic acid and/or phosphate ether groups as described above. This solvent-borne composition may be used as the second component in the multi-component coating composition described above.

The solvent-borne composition may further comprise a second polyisocyanate not having sulfonic acid and/or phosphate ether groups, as described above. The second polyisocyanate may be an aliphatic polyisocyanate.

In the solvent-borne composition, when additionally a second polyisocyanate having neither sulfonic acid nor phosphate ether groups is used, the water-dispersible polyisocyanate and the second polyisocyanate may be used in a weight ratio ranging of from 1:10 to 10:1, or of from 5:1 to 1:5, or of from 3:1 to 1:3, or of from 2:1 to 1:2. For example, the water-dispersible polyisocyanate and the second polyisocyanate may be used in a weight ratio of 1:1.

The polyisocyanates may be present in the solvent-borne composition in an amount of at least 30 wt.-%, such as at least 40 wt.-%, such as at least 50 wt.-%, such as at least 60 wt.-%, such as at least 70 wt.-%, such as at least 80 wt.-% based on the total weight of the resin solids in the solvent-borne composition. The polyisocyanates may be present in the second solvent-borne component in an amount of no more than 90 wt.-%, such as no more than 85 wt.-%, such as no more than 80 wt.-% based on the total weight of the resin solids in the solvent-borne composition. Ranges of polyisocyanate may include, for example, from 30 to 90 wt.-%, such as from 30 to 85 wt.-%, such as from 30 to 80 wt.-%, such as from 40 to 90 wt.-%, such as from 50 to 90 wt.-%, such as from 60 to 90 wt.-%, such as from 70 to 90 wt.-%, such as from 80 to 90 wt.-%, based on the total weight of the resin solids in the solvent-borne composition. The polyisocyanate may be present in the solvent-borne composition in the range between any of the above-mentioned values such as from 40 to 85 wt.-%, such as from 50 to 85 wt.-%, such as from 60 to 80 wt.-%, such as from 70 to 85 wt.-%, based on the total weight of the resin solids in the solvent-borne composition.

The solvent-borne composition may be substantially free of water, alcoholic and/or ether solvents, i.e., the solvent-borne composition may comprise less than 5.0 wt.-%, such as less than 3.0 wt.-%, such as less than 2.0 wt.-%, such as less than 1.0 wt.-% of water, alcoholic and/or ether solvents. The solvent-borne composition may be essentially free of water, alcoholic and/or ether solvents, i.e., solvent-borne composition may comprise less than 0.5 wt.-%, such as less than 0.2 wt.-%, such as less than 0.1 wt.-% of water, alcoholic and/or ether solvents.

The solvent-borne composition may be substantially free of water i.e., the solvent-borne composition may comprise less than 5.0 wt.-%, such as less than 3.0 wt.-%, such as less than 2.0 wt.-%, such as less than 1.0 wt.-% of water. The solvent-borne composition may be essentially free of water i.e., solvent-borne composition may comprise less than 0.5 wt.-%, such as less than 0.2 wt.-%, such as less than 0.1 wt.-% of water.

The solvent-borne composition may be substantially free of alcoholic solvents i.e., the solvent-borne composition may comprise less than 5.0 wt.-%, such as less than 3.0 wt.-%, such as less than 2.0 wt.-%, such as less than 1.0 wt.-% of alcoholic solvents. The solvent-borne composition may be essentially free of alcoholic solvents i.e., solvent-borne composition may comprise less than 0.5 wt.-%, such as less than 0.2 wt.-%, such as less than 0.1 wt.-% of alcoholic solvents.

The solvent-borne composition may be substantially free of ether solvents i.e., the solvent-borne composition may comprise less than 5.0 wt.-%, such as less than 3.0 wt.-%, such as less than 2.0 wt.-%, such as less than 1.0 wt.-% of ether solvents. The solvent-borne composition may be essentially free of ether solvents i.e., solvent-borne composition may comprise less than 0.5 wt.-%, such as less than 0.2 wt.-%, such as less than 0.1 wt.-% of ether solvents.

The present disclosure further relates to a method of coating a substrate. The method comprises applying a composition to at least a portion of a surface of the substrate to form a coating layer, the composition comprising: a first solvent-borne component comprising an active hydrogen-containing polyfunctional compound, and a second solvent-borne component comprising a water-dispersible polyisocyanate having sulfonic acid and/or phosphate ether groups.

According to the present disclosure, the method can further comprise curing the coating layer.

The multi-component coating composition used in the disclosed method may be any of the multi-component coating compositions described above.

According to the disclosed method, the coating composition can be applied to at least a part of a surface of a substrate by any means standard in the art, such as by brushing, spraying, dipping, printing, flowing, and the like. Spraying may be accomplished by compressed air spraying or electrostatic spraying. The coating composition can be applied to at least a part of a surface of the substrate to obtain a dry coating thickness of at least 20 μm, or of at least 30 μm, or of at least 40 μm, or of at least 50 μm. The coating composition can be applied to at least a part of a surface of the substrate to obtain a dry coating thickness of 150 μm or less, such as of 130 μm or less, or of 100 μm or less, or of 80 μm or less. The coating composition can be applied to at least a part of a surface of the substrate to obtain a dry coating thickness in a range between any of the above-mentioned values such as from 20 to 150 μm, such as from 30 to 130 μm, such as from 40 to 100 μm, such as from 50 to 80 μm. The thickness can be determined according to DIN EN ISO 2178:2016. As used herein, the “dry coating thickness” is the thickness of a coating, which is applied to at least a part of a surface of a substrate, measured above the substrate after the coating is cured.

The coating composition may be cured by thermally curing. Thermally curing refers to exposing the coating composition to a temperature above room temperature in order to effect an at least partial curing of the coating composition. The temperature for thermally curing the coating composition may be at least 60° C., such as at least 70° C., such as at least 80° C., such as at least 90° C., such as at least 100° C., such as at least 110° C., such as at least 120° C. The curing temperature may be 160° C. or less, such as 150° C. or less, such as 140° C. or less, such as 130° C. or less. The temperature for curing the coating composition may be from 60° C. to 160° C., such as from 60° C. to 150° C., such as from 60° C. to 140° C., such as from 60° C. to 130° C., such as from 70° C. to 160° C., such as from 70° C. to 150° C., such as from 70° C. to 140° C., such as from 70° C. to 130° C., such as from 80° C. to 160° C., such as from 80° C. to 150° C., such as from 80° C. to 140° C., such as from 80° C. to 130° C., such as from 90° C. to 160° C., such as from 90° C. to 150° C., such as from 90° C. to 140° C., such as from 90° C. to 130° C., such as from 100° C. to 160° C., such as from 100° C. to 150° C., such as from 100° C. to 140° C., such as from 100° C. to 130° C., such as from 110° C. to 160° C., such as from 110° C. to 150° C., such as from 110° C. to 140° C., such as from 110° C. to 130° C., such as from 120° C. to 160° C., such as from 120° C. to 150° C., such as from 120° C. to 140° C., such as from 120° C. to 130° C. The coating composition may be cured for at least 2 min, such as for at least 5 min, such as for at least 10 min, such as for at least 15 min, such as for at least 20 min, such as for 45 min or less, such as for 40 min or less, such as for 35 min or less, such as for 25 min or less, such as for 20 min or less. The time for curing the coating composition may be in a range between any of the above-mentioned values, such as from 2 min to 45 min, such as from 5 min to 40 min, such as from 10 min to 35 min, such as from 15 min to 30 min, such as from 20 min to 25 min.

The terms “cure”, “cured” or similar terms, as used in connection with the coating composition described herein, means that at least a portion of the components that form the coating composition is crosslinked to form a coating.

The coating composition can be applied to a wide range of substrates. For example, the substrate, specifically a part of the surface of the substrate to which the coating composition is applied, can comprise at least one material selected from metals, plastics, ceramics, such as boron carbide or silicon carbide, glass, wood, paper, cardboard, rubber, leather, textiles, fiberglass composite, carbon fiber composite, an existing coating, or mixtures thereof.

Metals may include, but are not limited to, ferrous metals, tin steel, aluminum, aluminum alloys, zinc-aluminum alloys, titanium, titanium alloys, magnesium, magnesium alloys, copper, copper alloys and mixtures. The ferrous metal may include iron, steel, and alloys thereof. Non-limiting examples of useful steel materials may include rolled steel, galvanized (zinc coated) steel, electrogalvanized steel, stainless steel, pickled steel, zinc-iron alloy, and combinations thereof. Combinations of ferrous and non-ferrous metals can also be used. Aluminum alloys of the 1XXX, 2XXX, 3XXX, 4XXX, 5XXX, 6XXX, 7XXX or 8XXX series as well as clad aluminum alloys and cast aluminum alloys of the A356, 1 XX.X, 2XX.X, 3XX.X, 4XX.X, 5XX.X, 6XX.X, 7XX.X or 8XX.X series also may be used as the substrate. Magnesium alloys of the AZ31 B, AZ91C, AM60B or EV31A series also may be used as the substrate. The substrate may be pretreated with pretreatment solution including a zinc phosphate pretreatment solution such as, e.g., those described in U.S. Pat. Nos. 4,793,897 and 5,588,989, or a zirconium containing pretreatment solution such as, e.g., those described in U.S. Pat. Nos. 7,749,368 and 8,673,091.

Plastics may include, but are not limited to, polyethylene terephthalate (PET), polyethylene (PE), such as high-density polyethylene (HDPE) or low-density polyethylene (LDPE), polyvinyl chloride (PVC), polypropylene (PP), polycarbonate (PC), polyurethanes (PUR), polystyrene (PS), as well as blends, composites, or mixtures thereof.

As used herein, the term “multi-component coating composition” refers to a composition comprising more than one component, such as two or more components. As used herein, a “two-component” or “2K” coating composition is a composition in which at least a portion of the reactive components readily react and at least partially cure without activation from an external energy source, such as at ambient temperatures, e.g., temperatures in the range of from 20° C. to 25° C., or slightly elevated temperatures, e.g., temperatures in the range of from 25° C. to 60° C., when mixed. One of skill in the art understands that the two components of the coating composition are stored separately from each other and mixed prior to application of the coating composition.

The coating composition may be a primer coating composition and/or a basecoat composition and/or a top coat composition. Moreover, the coating composition may be a clear coat composition and/or a colored coating composition. The coating composition may be a 2K clear coat composition.

The present disclosure further relates to a substrate comprising a cured coating layer obtained from the multi-component coating composition as previously described. The coated substrate can be selected from vehicles, storage tanks, windmills, packaging substrates, wood flooring and furniture, apparel, electronics, glass and transparencies, sports equipment, buildings, bridges, and the like, or parts thereof. For example, the coated substrate can be a vehicle part. The cured coating layer on the substrate may be applied by a method described above.

The term “vehicle” is used in its broadest sense and includes (without limitation) all types of aircraft, spacecraft, watercraft, and ground vehicles. For example, a vehicle can include aircraft such as airplanes, including private aircraft, and small, medium, or large commercial passenger, freight, and military aircraft; helicopters, including private, commercial, and military helicopters; aerospace vehicles including, rockets and other spacecrafts. Vehicles can include ground vehicles such as, for example, trailers, cars, trucks, buses, coaches, vans, ambulances, fire engines, motorhomes, caravans, go-karts, buggies, fork-lift trucks, sit-on lawnmowers, agricultural vehicles such as, for example, tractors and harvesters, construction vehicles such as, for example, diggers, bulldozers and cranes, golf carts, motorcycles, bicycles, trains, and railroad cars. Vehicles can also include watercraft such as, for example, ships, submarines, boats, jet-skis and hovercraft.

The present disclosure further relates to use of a water-dispersible polyisocyanate, which has sulfonic acid and/or phosphate ether groups, as a curing agent in a solvent-borne coating composition for improving chemical resistance, scratch resistance, mar resistance and/or appearance of a coating obtained from said coating composition, in comparison to a coating obtained from the same coating composition cured using a polyisocyanate having neither sulfonic acid nor phosphate ether groups.

As used herein, the terms “scratch resistance” and “mar resistance” refer to the resistance of a material to damage from impact, rubbing or abrasion that produces visible scratches or marring. Scratch and mar resistance may be determined according to DIN EN ISO 20566:2021 and DIN EN ISO 21546:2021, respectively. As used herein, the term “chemical resistance” refers to the resistance of a material to the effects of chemicals, such as, e.g., discoloration, alteration in the degree of shine, softening, swelling, detachment of coatings, or blistering. Chemical resistance towards at least one of acids, enzymes and tree sap, or a combination thereof may be determined according to DIN EN ISO 2812-5:2018.

In addition, the appearance of the coating obtained from the disclosed coating composition is enhanced in comparison to a coating obtained from the same coating composition cured using a polyisocyanate having neither sulfonic acid nor phosphate ether groups. Improved appearance properties are, for example, a reduced surface waviness and a higher gloss of the coating.

Surface waviness is an indication of the roughness of a surface, and may be measured using a wave scan instrument such as the BYK Wave-scan Dual instrument available from BYK Gardner USA, which measures surface topography via an optical profile. The wave scan instrument uses a point source (i.e., a laser) to illuminate the surface over a predetermined distance, for example 10 centimeters, at an angle of incidence of 60°. The reflected light is measured at the same, but opposite angle. As the light beam hits a “peak” or “valley” of the surface, a maximum signal is detected. When the light beam hits a “slope” of a peak/valley, a minimum signal is detected. The measured signal frequency is equal to double spatial frequency of the coating surface topography. The surface “waviness” is differentiated into longterm and shortterm waviness (“longwave” and “shortwave”) to simulate visual evaluation by the human eye. Data are divided into longwave (structure size >0.6 mm) and shortwave (structure size <0.6 mm) signals using a mathematical filter function. Each range in value from 0 to 50. Longterm waviness represents the variance of the longwave signal amplitude, while the shortterm waviness represents variance of the shortwave signal amplitude. The long- and shortterm waviness of a coating surface can give an indirect measure of topography-influencing factors such as substrate roughness, and flow and leveling properties of coatings. Longwave and shortwave values may be determined using the BYK Wave-scan Dual instrument from BYK Gardner, Maryland, USA in accordance with the manufacturer's suggested method of operation. Longwave and shortwave values of lesser magnitude are indicative of coatings that are smoother in appearance.

As used herein, the term “gloss” refers to the surface gloss of a coating and is related to the amount of light that is reflected at the specular reflectance angle of 20°. The gloss values may be measured using the BYK Wave-scan Dual instrument in accordance with the manufacturer's suggested method of operation. The gloss may be determined according to DIN EN ISO 2813:2015-02.

As used herein, unless otherwise expressly specified, all numbers such as those expressing values, ranges, amounts or percentages may be read as if prefaced by the word “about”, even if the term does not expressly appear.

The following examples are intended to illustrate the present disclosure and should not be construed as limiting in any way.

### EXAMPLES

### Preparation of Two-Component (2K) Coating Compositions

2K clear coat coating compositions were prepared by mixing Component A and Component B.1, B.2, or B.3, respectively, as listed in Table 1.

TABLE 1
2K coating compositions

| | Parts per weight [%] |
|---|---|
| Component A | |
| Acrylic resin¹ | 35.9 |
| Polyester resin² | 2.75 |
| Melamine resin³ | 4.22 |
| UV light absorber⁴ | 4.31 |
| Hindered amine light stabilizer⁵ | 0.59 |
| Flow control agent⁶ | 0.01 |
| Defoamer⁷ | 0.04 |
| Catalyst⁸ | 0.9 |
| Sag control agent⁹ | 22.60 |
| Solvent¹⁰ | 28.68 |
| Component B.1 (comparative) | |
| Polyisocyanate¹¹ | 78.00 |
| Solvent¹² | 22.00 |
| Component B.2 (hydrophilic) | |
| Polyisocyanate¹³ | 39.70 |
| Polyisocyanate¹¹ | 39.00 |
| Solvent¹² | 21.30 |
| Component B.3 (hydrophilic) | |
| Polyisocyanate¹⁴ | 39.50 |
| Polyisocyanate¹¹ | 39.00 |
| Solvent¹² | 22.00 |

¹Acrylic polyol as dispersion in Solvent naphtha/butyl acetate having a solid content of 65%, hydroxyl value [mg KOH/g]: 150, acid value [mg KOH/g]: 3.2-6.0, Tg [° C.]: 60, and viscosity (23° C., 100 s⁻¹) [Pa · s]: 3.3-6.5.
²OH-functional polyester solution in butyl acetate having a solid content of 70%, hydroxyl value [mg KOH/g]: 280, acid value [mg KOH/g]: 85, Tg [° C.]: 18, and viscosity (23° C., 1000 s⁻¹) [Pa · s]: 4.4.
³Highly butylated melamine resin having a minimum solid content of 96%, free formaldehyde <0.1%, viscosity (25° C.) [Pa · s]: 2.8-5.6, equivalent weight (g/eq): 200-300.
⁴Tinuvin 928 commercially available from BASF (Germany).
⁵Tinuvin 123 commercially available from BASF (Germany).
⁶Polyether-modified polydimethylsiloxane.
⁷Polyacrylate solution in xylene.
⁸Amine-neutralized dodecylbenzene sulfonic acid in isopropanol containing approx. 40% active acid and having an acid value [mg KOH/g] of 69-79.
⁹Setalux 91767 VX-60 commercially available from Allnex (Germany).
¹⁰Mixture of isoamyl acetate, Aromatic 100 commercially available from Exxon Mobil Corporation (Irving, TX, USA), butyl acetate, ethyl 3-ethoxypropionate, diethylene glycol butyl ether acetate and 2-butoxyethyl acetate in an approximate mixing ratio of 42:0.5:13:13:4.5:27.
¹¹HMDI trimer having an NCO content [%]: 21.8, viscosity (23° C.) [Pa · s]: 2.25-3.75, density (20° C.) [g/cm³]: 1.16.
¹²Butyl acetate.
¹³HMDI trimer having phosphate ether groups and an NCO content [%]: 20.7-22.7, viscosity (25° C.) [Pa · s]: 1.1-1.9, density (25° C.) [g/cm³]: 1.17.
¹⁴HMDI trimer having sulfonic acid groups and an NCO content [%]: 21.0-22.0, viscosity (25° C.) [Pa · s]: 1.5-3.5, density (25° C.) [g/cm³]: 1.16.

The hydroxyl value was determined according to DIN EN ISO 4629-1:2016. The glass transition temperature (Tg) was determined according to DIN EN ISO 168025:2005. The acid value was determined according to ISO 2114:2002. The viscosity was determined according to DIN EN ISO 3219-1:2021. The free formaldehyde content was determined according to DIN EN ISO 11402:2005-09. The NCO content was determined according to DIN EN ISO 11 909:2007-05. The solid content was determined according to DIN EN 3251:2019. The density was determined according to DIN EN ISO 2811.

### Coating of Substrate

The coating compositions obtained after mixing Component A with Component B.1, B.2 or B.3, respectively (mixing ratio=100:36 per weight) were spray applied with an electrostatic spray bell from Dürr AG (Stuttgart, Germany) onto E-coated steel substrates available from ACT Test Panels LLC (Hillsdale, MI, USA). The dry film thickness of the coating composition ranged of from 40 to 50 μm determined according to DIN EN ISO 2178:2016.

### Curing of Coated Substrates Using an Oven

The substrates coated with the coating compositions shown in Table 1 were cured using heated air in an oven (HORO Dr. Hofmann GmbH (Ostfildern, Germany)) at 140° C. for 30 min.

### Measurement of Properties of the Cured Coatings

Properties of the cured coatings were measured. Scratch resistance of the cured coatings simulating a car wash system was measured as residual gloss according to DIN EN ISO 20566:2021. Chemical resistance to treesap, surface waviness and gloss were measured as described above.

TABLE 2
Properties of cured coating compositions

| | Comparative | | |
|---|---|---|---|
| | Composition 1 | Composition 2 | Composition 3 |
| | (A + B.1) | (A + B.2) | (A + B.3) |
| Property | | | |
| Residual gloss [%] | 83 | 88 | 87 |
| after 10x carwash | | | |
| Residual gloss [%] | 65 | 78 | 77 |
| after 20x carwash | | | |
| Residual gloss [%] | 52 | 70 | 68 |
| after 30x carwash | | | |
| Chemical resistance | 39 | 69 | 74 |
| Treesap (° C.) | | | |
| Appearance | | | |
| Longwave vertical | 7.2 | 6.5 | 6.3 |
| Shortwave vertical | 19.4 | 18 | 17.2 |
| Longwave horizontal | 4.7 | 4 | 3.8 |
| Shortwave horizontal | 20.2 | 19.8 | 20 |
| Gloss | 88 | 93 | 92 |

From Table 2, it can be seen that enhanced chemical, scratch, and mar resistance can be achieved by using a water-dispersible polyisocyanate having sulfonic acid (Composition 3) or phosphate ether groups (Composition 2). Moreover, it has surprisingly been found that the appearance of the cured coatings comprising these polyisocyanates was also improved in comparison to a coating composition not containing a water-dispersible polyisocyanate having sulfonic acid or phosphate ether groups. This is particularly surprising because appearance and resistance are often countercurrent effects. However, the values for longwave and shortwave were at least comparable or even lower for compositions according to the present disclosure in comparison to compositions not containing a water-dispersible polyisocyanate having sulfonic acid or phosphate ether groups (Comparative Composition 1). Lower longwave and shortwave values are generally considered more aesthetic and desirable in coating compositions. The coating compositions of the present disclosure further showed improved gloss values.

1. A multi-component coating composition, comprising:
a first solvent-borne component comprising an active hydrogen-containing polyfunctional compound, and a second solvent-borne component comprising a water-dispersible polyisocyanate having sulfonic acid and/or phosphate ether groups.

2. The composition of claim 1, wherein the active hydrogen-containing polyfunctional compound is selected from the group consisting of polyols, polyamines, polythiols and mixtures thereof.

3. The composition of claim 1, wherein the active hydrogen-containing polyfunctional compound comprises or is a polyol.

4. The composition of claim 2, wherein the polyol comprises a (meth)acrylic polyol, a polyester polyol, or a combination thereof.

5. The composition of claim 2, wherein the polyol is present in the first component in an amount of from 30 to 99.8 wt. %, based on the total weight of the resin solids in the first solvent-borne component.

6. The composition of claim 1, wherein the first solvent-borne component further comprises a melamine-based compound.

7. The composition of claim 6, wherein the first solvent-borne component comprises the melamine-based compound in an amount of from 0.2 to 30 wt. %, based on the total weight of resin solids in the first solvent-borne component.

8. The composition of claim 1, wherein the first and/or second solvent-borne component further comprises one or more compounds selected from the group consisting of additional polymers different from the active hydrogen-containing polyfunctional compound, hindered amine light stabilizers, ultraviolet light stabilizers, ultraviolet light absorbers, curing catalysts, corrosion inhibitors, adhesion promoters, rheology modifiers, levelling agents, sag control agents, surfactants, fillers, matting agents, abrasion-resistant particles, colorants, anti-oxidants, reactive diluents, plasticizers, effect pigments and combinations thereof.

9. The composition of claim 1, wherein the water-dispersible polyisocyanate is prepared from an aliphatic diisocyanate.

10. The composition of claim 1, wherein the water-dispersible polyisocyanate has an NCO content on solids in the range of from 8 to 25%, determined according to DIN EN ISO 11 909:2007-05.

11. The composition of claim 1, wherein the second solvent-borne component further comprises a second polyisocyanate having neither sulfonic acid nor phosphate ether groups.

12. The composition of claim 11, wherein the second polyisocyanate is an aliphatic polyisocyanate.

13. The composition of claim 11, wherein the water-dispersible polyisocyanate and the second polyisocyanate are used in a weight ratio ranging of from 1:10 to 10:1.

14. The composition of claim 1, wherein the water-dispersible polyisocyanate is present in an amount of from 30 to 90 wt. %, based on the total weight of resin solids in the second solvent-borne component.

15. The composition of claim 1, comprising 50 to 90 wt.-% of the first component and 10 to 50 wt.-% of the second component, based on the combined total resin solids weight of the first and the second component.

16. The composition of claim 1, wherein the solvent of the first and/or second solvent-borne component each independently comprises an aromatic solvent, an alkyl acetate solvent, an aliphatic solvent, a ketone solvent, or combinations thereof.

17. The composition of claim 1, wherein the first component and/or the second component each independently are substantially free of water, alcoholic solvents, and/or ether solvents.

18. The composition of claim 1, wherein the composition is a two-component clear coat composition.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A substrate comprising a cured coating layer obtained from the multi-component coating composition according to claim 1.

32. (canceled)

33. (canceled)
